(19) United States
(12) Patent Application Publication
(10) Pub. No.: US 2010/0261032 A1
(43) Pub. Date: Oct. 14, 2010

(54) SINGLE WIRE STEEL CORD

(76) Inventors: Hyung-Eun Lee, Ulsan Metropolitan City (KR); Min-An Kim, Ulsan Metropolitan City (KR)

Correspondence Address: DICKSTEIN SHAPIRO LLP, 1825 EYE STREET NW, Washington, DC, 20006-5403, US

(21) Appl. No.: 12/739,047

(22) PCT Filed: Dec. 18, 2007
(86) PCT No.: PCT/KR07/06610

§ 371 Date: Apr. 21, 2010

(30) Foreign Application Priority Data
Nov. 6, 2007 (KR) 10-2007-0112418

(51) Int. Cl. B32B 1/00

(52) U.S. Cl. 428/603

(57) ABSTRACT

The present invention relates to a single wire steel cord for reinforcing rubber of a pneumatic tire having improved strength and adhesion to rubber and, more particularly, to a single wire steel cord which includes waveform regions having at least one waveform and non-waveform regions. The single wire steel cord has a high strength characteristic. Accordingly, the amount of steel cord is significantly reduced during manufacturing of a tire. As a result, the weight of the tire is reduced and manufacturing cost is lowered due to a simplified manufacturing process.

### TECHNICAL FIELD

The present invention relates to a single wire steel cord for reinforcing rubber of a pneumatic tire, wherein said cord has improved strength and adhesion to rubber. More particularly, the present invention relates to a single wire steel cord which includes waveform regions having at least one waveform and non-waveform regions.

### BACKGROUND ART

In recent years, many studies have been conducted to improve fuel efficiency of vehicles because of various factors such as protection of a global environment, and in order to achieve this, researches for developing lightweight tires are in progress. Accordingly, there is a pressing need to develop a slim and light-weight single wire steel cord.

In general, a steel cord having a 1×n structure is used in a belt layer of a radial tire for passenger cars. The steel cord having the above structure has high rigidity. It gives, however, too strong repulsive force to the tire on unpaved roads, which makes a passenger uncomfortable. Additionally, the steel cord enables cracks to be formed on a surface of a tread, and rain to flow through the cracks into the tire to result in early corrosion of a cord wire. Furthermore, if the tire is transformed or vibrated, the wires which are twisted and combined with each other are rubbed each other to be worn, which is called fretting wear. For this reason, there is a problem in that the cord wire is easily broken due to fatigue.

In order to avoid the above-mentioned problems, application of a single wire steel cord, which is produced by processing one ply of filament instead of the steel cord produced by twisting a plurality of plies of wires, to a belt layer of a tire has been suggested. The reason is that the single wire steel cord has the plasticity that is better than that of a steel cord having a strand structure.

However, in the case of a known cord having a strand structure (1×n) or a single wire steel cord which includes a filament having a circular cross section, there is a problem in that the rotation or the arc height of the cord highly depends on the material of wires or the machines such as a drawing machine or an elongation machine. In particular, the rotation significantly depends on them. Accordingly, the rotation of products is tested for each product in respects to a typical level of warranty of quality.

Therefore, a single wire steel cord having a cross section that is not circular has been suggested. Japanese Patent No. 11/143234 discloses that a flat single wire steel cord is processed to have a wave shape in order to improve the arc height and the rotation of the steel cord. Korean Patent No. 10-0318896 discloses that a flat single wire steel cord is subjected to twisting to improve adhesion. Furthermore, Korean Patent No. 10-0567812 discloses that twist stress is provided to a flat single wire steel cord to form helix parts at regular intervals, so that properties such as adhesion and elongation are improved.

As described above, currently, a flat single wire steel cord is mainly used instead of a circular single wire steel cord.

### DISCLOSURE OF INVENTION

### Technical Problem

The present invention has been made keeping in mind the above disadvantages. One object of the present invention is to provide a single wire steel cord which has improved properties such as rotation and elongation at break, improved impact resistance against rough movement of a tire, excellent rotation (residual rotation stress), arc height (AH), and adhesion, and improved workability, and a method for manufacturing the same.

### Technical Solution

In order to avoid the above disadvantages, the present invention provides a single wire steel cord which includes waveform regions having at least one waveform and non-waveform regions.

### Advantageous Effects

The single wire steel cord according to the present invention has the effects that the rotation is improved and the elongation at break is increased to improve impact resistance against rough movement of tires and to improve the rotation (residual rotation stress), the arc height (AH), and the adhesion, and that productivity is improved because the process for manufacturing product is simple.

### BRIEF DESCRIPTION OF DRAWINGS

FIGS. 1 to 3 are views illustrating manufacturing of a single wire steel cord according to the present invention.

### BEST MODE FOR CARRYING OUT THE INVENTION

Hereinafter, preferable embodiments of the present invention will be described with reference to the accompanying drawings. In the accompanying drawings, the length, the wire diameter, the number of waveforms, and the like are exaggerated for convenience. Like reference numerals designate like elements throughout the specification.

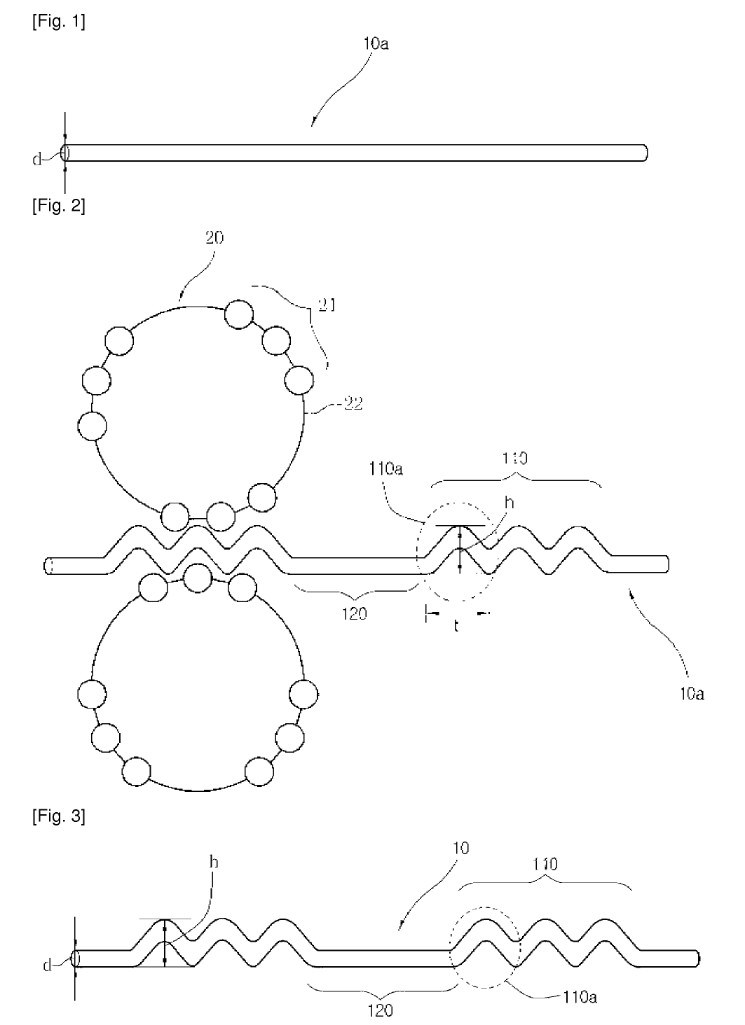

FIGS. 1 to 3 are views illustrating manufacturing of a single wire steel cord according to the present invention.

With reference to FIG. 1, a filament 10a is provided which has carbon content in the range of 0.7 to 2%, tensile strength in the range of 270 to 480 kg/mm², and a wire diameter d in the range of 0.2 to 1 mm.

When the filament 10a has the tensile strength in the range of 270 to 480 kg/mm² and the wire diameter d in the range of 0.2 to 1 mm, it is possible to manufacture a filament, which is capable of being used as a steel cord, without an increase in manufacturing time and manufacturing cost.

The Filament 10a may be manufactured by a process comprising:

First-drawing a wire rod to form a pre-filament;

Patenting-treatment said pre-filament;

Plating with brass; and

Drawing the plated several time to form the filament 10a.

In connection with this, it is preferable that the wire rod be a carbon steel having a carbon content in the range of 0.7 to 2% and have a diameter of 5.5 mm which is a common standard.

With reference to FIG. 2, the filament 10a is provided between helix units 20 including waveform forming parts 21 and waveform non-forming parts 22 to form waveforms 110a in the filament 10a.

In connection with this, it is preferable that the wavelength t of the waveform 110a is in the range of 1 to 10 mm and the height h of the waveform 110a is in the range of 0.24 to 3.0 mm. If the wavelength t and the height h of the waveform 110a satisfy the above-mentioned range, there is an advantage in that products having desired elongation can be manufactured.

In this connection, in the filament, regions which correspond to the waveform forming parts 21 are called waveform regions 110 and regions which correspond to the waveform non-forming parts 22 are called non-waveform regions 120.

It is preferable that each of the helix units 20 be made of a sintered alloy (WC), and each of the waveform forming parts 21 may be modified according to the shape of waveform.

With reference to FIG. 3, the procedure which is described with regard to FIG. 2 is repeated to manufacture the single wire steel cord 10 which includes the waveform regions 110 in the shape of a wave having at least one waveform 110a and the non-waveform regions 120 and which has elongation in the range of 0.5 to 3%.

It is preferable that the waveform regions 110 and the non-waveform regions 120 alternate at a length ratio of 1:9 to 9:1. If the waveform regions 110 and the non-waveform regions 120 alternate at the above-mentioned length ratio, there is an advantage in that it is easy to control the arc height and the elongation.

To be more specific, it is preferable that the lengths of the waveform regions 110 and the non-waveform regions 120 be in the range of 1 to 100 mm, and if the lengths satisfy the above-mentioned range, there is an advantage in that it is easy to control the arc height and the rotation.

In addition, it is preferable that each of the waveform regions 110 have 1 to 100 waveforms 110a. More preferably, each of the waveform regions 110 has 1 to 10 waveforms 110a. If the above-mentioned range is satisfied, there is an advantage in that it is easy to control the arc height and the rotation.

In the single wire steel cord 10, it is preferable that a forming ratio be in the range of 120 to 300%.If the above-mentioned range is satisfied, there is an advantage in that the arc height is improved and the elongation may be controlled to have a desired value.

Forming ratio=(h (height of waveform)/d(wire diameter))×100

The single wire steel cord according to the present invention has the effects that rotation is improved and elongation at break is increased, to improve impact resistance against rough movement of tires and to improve the rotation (residual rotation stress), the arc height (AH), and the adhesion, and that productivity is improved because of simple process for manufacturing the products.

### MODE FOR THE INVENTION

A better understanding of the present invention may be obtained in light of the following Examples which are set forth to illustrate, but are not to be construed to limit the present invention.

### 1) Example 1

The wire rod which has the carbon content of 0.82% and the diameter of 5.5 mm was subjected to the first drawing process to have the wire diameter of 1.90 mm, and then subjected to patenting treatment and plated with brass. After that, it was subjected to the second drawing process to have a diameter of 0.40 mm, to prepare the filament. Next, the waveforms were formed by using the helix units in a partial area of the filament in such a way that each of the waveform regions include four waveforms and have a length of 10 mm and that each of the non-waveform regions have a length of 10 mm. The steel cord was manufactured by using the straightening R/Q and physical properties thereof were evaluated. The results are described in the following Table 1.

### 2) Comparative Example 1

The wire rod which has the carbon content of 0.82% and the diameter of 5.5 mm was subjected to the first drawing process to have the wire diameter of 1.90 mm, and then subjected to patenting treatment and plated with brass. After that, it was subjected to the second drawing process to have the diameter of 0.40 mm, to prepare the filament. The steel cord was manufactured by using the filament and the straightening R/O, and physical properties thereof were evaluated. The results are described in Table 1.

### 3) Comparative Example 2

The wire rod which has the carbon content of 0.82% and the diameter of 5.5 mm was subjected to the first drawing process to have the wire diameter of 1.90 mm, and then subjected to patenting treatment, plated with brass. After that, it was subjected to the second drawing process to have the diameter of 0.40 mm, to prepare the filament. Next, the cord was treated by using the press roller so that an aspect ratio of short diameter/long diameter is 0.80, and the steel cord was manufactured by using the straightening R/O. Physical properties thereof were evaluated, and the results are described in the following Table 1.

### 4) Comparative Example 3

The wire rod which has the carbon content of 0.82% and the diameter of 5.5 mm was subjected to the first drawing process to have the wire diameter of 1.90 mm, and then subjected to patenting treatment, plated with brass. After that, it was subjected to the second drawing process to have the diameter of 0.40 mm, to prepare the filament. Next, the waveforms were formed by using the helix units in the entire area of the filament. The steel cord was manufactured by using the straightening R/O, and physical properties thereof were evaluated. The results are described in the following Table 1.

TABLE 1

| | | | Comparative | Comparative | Comparative |
|---|---|---|---|---|---|
| Samples | | Example 1 | Example 1 | Example 2 | Example 3 |
| Filament | Short diameter | 0.40 | 0.40 | 0.36 | 0.40 |
| | (mm) | | | | |
| | Long diameter | 0.40 | 0.40 | 0.45 | 0.40 |
| | (mm) | | | | |
| | Aspect ratio | 1 | 1 | 0.8 | 1 |

| | | | | |
|---|---|---|---|---|
| Length of waveform region (mm) | 10 | — | — | Total |
| | | | | region |
| Length of non-waveform region | 10 | — | — | — |
| (mm) | | | | |
| Rotation (rotations/6 m) | 0 | −6 | −2 | 0 |
| Arc height (AH) (mm/40 cm) | 5 | 10 | 20 | 28 |
| Elongation (%) | 2.0 | 0.8 | 0.8 | 4.6 |
| Adhesion (kg/0.5 in) | 22 | 16 | 17 | 22 |

With reference to Table 1, when compared with Comparative Example 1, Example 1 shows that the rotation (residual rotation stress) was improved, and the elongation at break was increased. Accordingly, impact resistance of the tire was improved against the rough movement.

When Example 1 and Comparative Example 2 were compared to each other, since the press R/O is used in Comparative Example 2, the arc height is poor, and workability is reduced during the rubber topping process and the topping sheet cutting process of the tire manufacturing.

The Examples shows that when the waveforms are formed in the filament by using the helix units, the elongation is increased to improve impact resistance of the tire against the rough movement thereof, the rotation (residual rotation stress) and the AH (arc height) are improved, and the adhesion becomes excellent.

When Example 1 and Comparative Example 3 were compared to each other, since the waveforms are formed in the entire area of the filament in Comparative Example 3, the elongation exceeded above what is required for the steel cord and the arc height becomes poor. As a result, the workability is reduced during the rubber topping process and the topping sheet cutting process of the tire manufacturing.

1. A single wire steel cord comprising:
waveform regions having at least one waveform; and
non-waveform regions.

2. The single wire steel cord according to claim 1, wherein the waveform regions and the non-waveform regions alternate at a length ratio of 1:9 to 9:1.

3. The single wire steel cord according to claim 1, wherein the single wire steel cord has elongation in the range of 0.5 to 3%.

4. The single wire steel cord according to claim 1, wherein each of the waveforms has a height in the range of 0.24 to 3.0 mm and a wavelength in the range of 1 to 10 mm.

5. The single wire steel cord according to claim 1, wherein a forming ratio of each of the waveforms is in the range of 120 to 300%.

6. The single wire steel cord according to claim 2, wherein the length of each of the waveform regions is in the range of 1 to 100 mm.

7. The single wire steel cord according to claim 2, wherein the length of each of the non-waveform regions is in the range of 1 to 100 mm.

8. The single wire steel cord according to claim 1, wherein the diameter of the single wire steel cord is in the range of 0.20 to 1.0 mm.

9. The single wire steel cord according to claim 1, wherein the carbon content of the single wire steel cord is in the range of 0.7 to 2% and the tensile strength of the single wire steel cord is in the range of 270 to 480 kg/mm².
